(19) United States
(12) Patent Application Publication
(10) Pub. No.: US 2013/0041515 A1
(43) Pub. Date: Feb. 14, 2013

(54) POWER GENERATING SYSTEM AND METHOD FOR CONTROLLING THE SAME

(71) Applicant: Li-Keng WANG, Taipei City (TW)

(72) Inventor: Li-Keng WANG, Taipei City (TW)

(73) Assignee: Du Pont Apollo Limited, Hong Kong (HK)

(21) Appl. No.: 13/207,427

(22) Filed: Aug. 11, 2011

(51) Int. Cl. G06F 1/26

(52) U.S. Cl. 700/287

(57) ABSTRACT

A power generating system for a building is provided, the building has a wall structure and a curtain wall covering the wall structure. The power generating system includes an energy conversion module, a detecting module, a control module and a regulating module. The energy conversion module is integrated with the curtain wall for generating a first electrical power. The detecting module is used for detecting a second electrical power related to the consumption of an electrical system of the building. The control module is communicatively connected with the energy conversion module and the detecting module, for generating a control signal based on the first electrical power and the second electrical power. Additionally, the regulating module is communicatively connected with the control module, for receiving the control signal and regulating a cooling fluid flow between the wall structure and the curtain wall based on the control signal.

### BACKGROUND

1. Technical Field

The present disclosure relates to a power generating system and a method for controlling the same. More particularly, the present disclosure relates to a power generating system for a building and a method for controlling the same.

2. Description of Related Art

Recently, as existing energy sources such as petroleum and coal are expected to be depleted, interests in alternative energy sources for replacing the existing energy sources are increasing. Among the alternative energy sources, solar energy have been particularly spotlighted since it is deemed to be infinite and pollution-free during use.

Photovoltaic (PV) devices are commonly used nowadays for converting sunlight directly into electrical power. To increase the electrical power output, a plurality of photovoltaic cells, also known as solar cells, are typically connected in series or parallel to form a photovoltaic module. Additionally, a power generating system can include a photovoltaic array, which includes a plurality of photovoltaic modules. The photovoltaic array is often disposed on the roof-top of a building or an open space to receive sunlight. To date, however, the conventional roof-top based systems are limited in photovoltaic capability because shading by building elements, equipment, and other constraints severely limit the area available for photovoltaic deployment.

Therefore, there is a need for incorporating photovoltaic devices in a larger area of a building structure for generating power more efficiently.

### SUMMARY

According to one embodiment of the present invention, a power generating system for a building having a wall structure and a curtain wall covering the wall structure includes an energy conversion module, a detecting module, a control module, and a regulating module. The energy conversion module is integrated with the curtain wall for generating a first electrical power. The detecting, module is for detecting a second electrical power related to the consumption of an electrical system of the building. The control module is communicatively connected with the energy conversion module and the detecting module for generating a control signal based on the first electrical power and the second electrical power. The regulating module is communicatively connected with the control module for receiving the control signal and regulating a cooling fluid flow between the wall structure and the curtain wall based on the control signal.

According to another embodiment of the present invention, a power generating system for a building having a wall structure and a curtain wall covering the wall structure includes an energy conversion module, a sensor, a control module, and a regulating module. The energy conversion module is integrated with the curtain wall for generating an electrical power. The sensor is for detecting a current temperature inside the curtain wall. The control module is communicatively connected with the sensor for generating a control signal based on the current temperature and a preset temperature. The regulating module is communicatively connected with the control module for receiving the control signal and regulating a cooling fluid flow between the wall structure and the curtain wall based on the control signal.

According to yet another embodiment of the present invention, a method for controlling a power generating system for a building having a wall structure and a curtain wall covering the wall structure includes steps of: detecting a first electrical power generated by an energy conversion module of the power generating system; detecting a second electrical power related to the consumption of an electrical system of the building; generating a control signal based on the first electrical power and the second electrical power; and regulating a cooling fluid flow between the wall structure and the curtain wall based on the control signal.

### BRIEF DESCRIPTION OF THE DRAWINGS

FIGS. 1A and 1B illustrate a power generating system for a building according to one embodiment of this invention, in which the openings 160 in FIG. 1A are opened, and the openings 160 in FIG. 1B are closed;

FIG. 2 is a block diagram of the power generating system as shown in FIGS. 1A and 1B;

FIG. 3 is a flowchart of a method according to one embodiment of this invention for controlling the power generating system as shown in FIGS. 1A and 1B;

FIG. 4 is a flowchart of step 34 as shown in FIG. 3;

FIG. 5 illustrates a power generating system for a building according to one embodiment of this invention;

FIG. 6 is a block diagram of the power generating system as shown in FIG. 5; and

FIG. 7 is a flowchart of a method according to one embodiment of this invention for controlling the power generating system as shown in FIG. 5.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

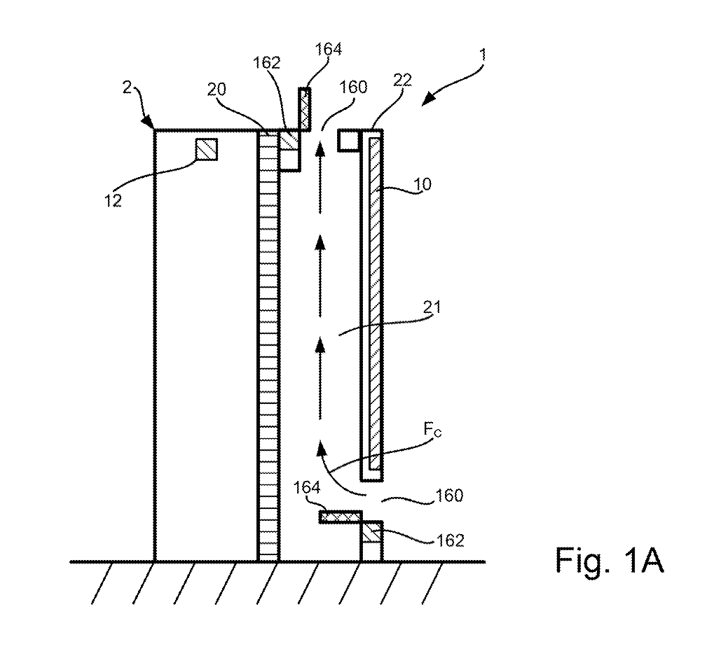

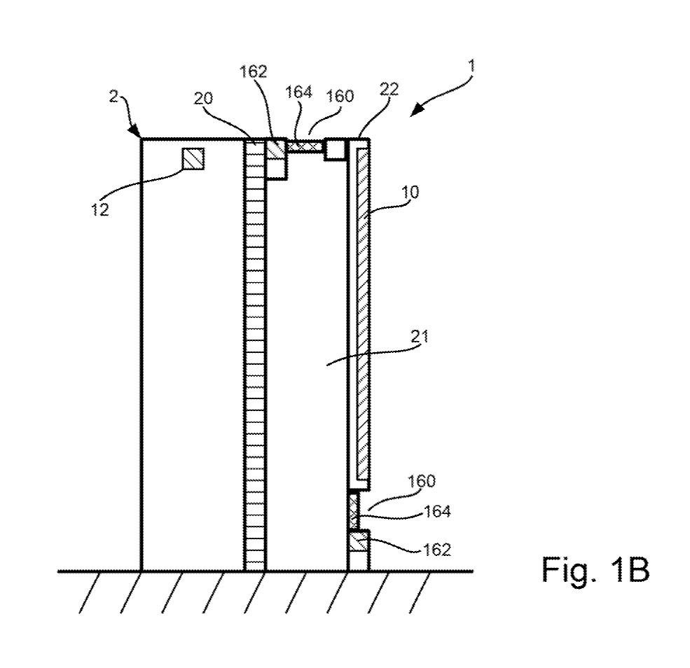

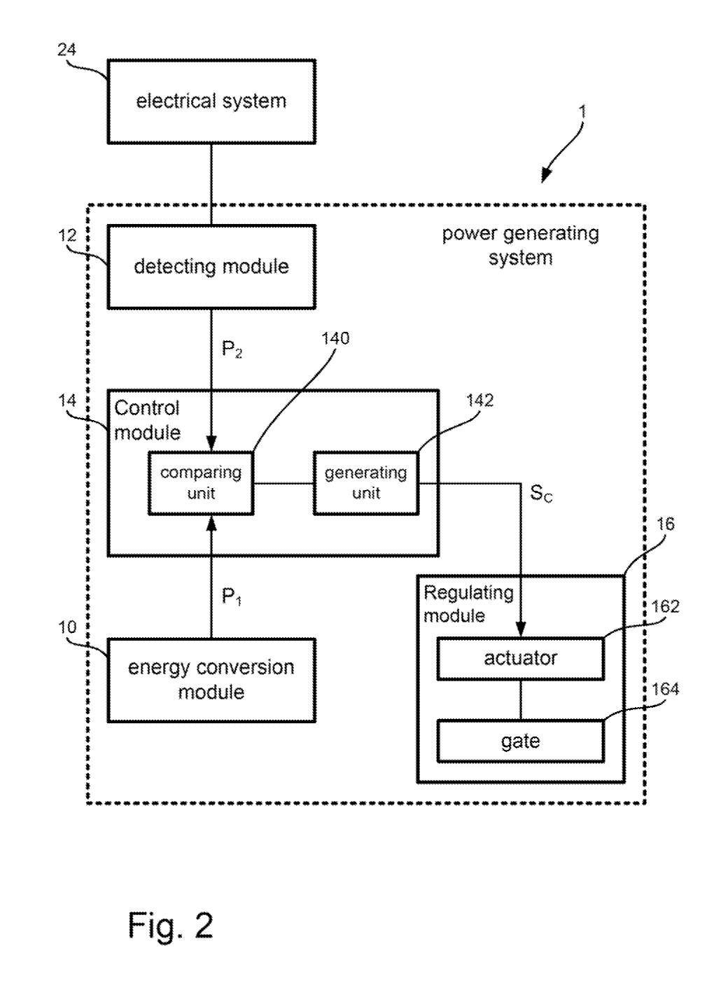

FIGS. 1A and 1B illustrate a power generating system 1 for a building according to one embodiment of this invention; and FIG. 2 is a block diagram of the power generating system 1 as shown in FIGS. 1A and 1B.

In this embodiment, the building 2 has a wall structure 20 and a curtain wall 22 covering the wall structure 20. The wall structure 20 and the curtain wall 22 can be constructed of any conventional material by a suitable method of construction. Additionally, the power generating system 1 includes an energy conversion module 10, a detecting module 12, a control module 14 and a regulating module 16.

The energy conversion module 10 can be integrated with the curtain wall 22 for generating a first electrical power P₁. For example, the energy conversion module 10 is, but not limited to, a photovoltaic module which converts sunlight directly into electrical power. In practice, the energy conversion module 10 can also be disposed on the top roof or other suitable locations of the building 2.

The detecting module 12 (e.g., an energy meter) can be disposed inside the building 2 and sensitively connected with an electrical system 24 of the building 2, for detecting a second electrical power P₂ related to the consumption of the electrical system 24. The electrical system 24, for example, can be an air conditioning system which can be used to control the temperature inside the building.

The control module 14 is communicatively connected with the energy conversion module 10 and the detecting module 12, for generating a control signal S_{C} based on the first electrical power P₁ and the second electrical power P₂. The control module 14 can be an integrated control unit (ICU), by way of example and not by way of limitation.

Additionally, the regulating module 16 is communicatively connected with the control module 14, for receiving the control signal S_{C} and regulating a cooling fluid flow F_{C} between the wall structure 20 and the curtain wall 22 based on the control signal S_{C}. It is observed that the cooling fluid flow F_{C} is helpful in lowering the temperature of the energy conversion module 10 and thus enhancing the performance thereof. In another word, with the cooling fluid flow F_{C}, the energy conversion module 10 can generate more electrical power than without the cooling fluid flow F_{C}.

As shown in FIG. 2, the control module 14 further includes a comparing unit 140 and a generating unit 142. The comparing unit 140 is communicatively connected with the energy conversion module 10 and the detecting module 12, for receiving and comparing the first electrical power P₁ and the second electrical power P₂. The generating unit 142 is connected with the comparing unit 140, and the generating unit 142 can be applied to generate the control signal S_{C} to make the regulating module 16 regulate the cooling fluid flow F_{C} to maximize the first electrical power P₁ generated by the energy conversion module 10 when the first electrical power P₁ is greater than the second electrical power P₂ consumed by the electrical system 24 of the building 2. The generating unit 142 can also be applied to generate the control signal S_{C} to make the regulating module 16 regulate the cooling fluid flow F_{C} to minimize the second electrical power P₂ when the first electrical power P₁ is smaller than the second electrical power P₂.

For example, in the case where the electrical system 24 is an air conditioning system and the temperature inside the building 2 is required to be higher than the temperature outside the building 2 (e.g., in winter), the generating unit 142 can generate the control signal S_{C} to make the regulating module 16 increase the cooling fluid flow F_{C} (i.e., the temperature between the wall structure 20 and the curtain wall 22 is lowered) to maximize the first electrical power P₁ when the first electrical power P₁ is greater than the second electrical power P₂. Alternatively, the generating unit 142 can generate the control signal S_{C} to make the regulating module 16 decrease the cooling fluid flow F_{C} (i.e., the temperature between the wall structure 20 and the curtain wall 22 is raised) to minimize the second electrical power P₂.

In this embodiment, the regulating module 16 may further includes at least one opening 160, an actuator 162 and at least one gate 164. The opening 160 can be disposed in fluid communication with a volume 21 defined between the wall structure 20 and the curtain wall 22 for allowing the cooling fluid flow F_{C} through the volume 21. In practice, a plurality of the openings 160 are disposed at different altitudes to facilitate ventilation. The actuator 162 is communicatively connected with the generating unit 142 of the control module 14 for receiving the control signal S_{C}. Additionally, the gate 164 is communicatively connected with the actuator 162 and operatively disposed with the opening 160 for controlling the opening 160 to regulate the cooling fluid flow F_{C}.

In practice, the gate 164 can be electrically and/or mechanically controlled by the actuator 162. Moreover, the gate 164 can control the opening 160 by keeping the opening 160 open (as shown in FIG. 1A) or close the opening 160 (as shown in FIG. 1B), by adjusting the area of the opening 160 or by changing the number of the openings 160 under “open” state or “close” state, by way of example and not by way of limitation.

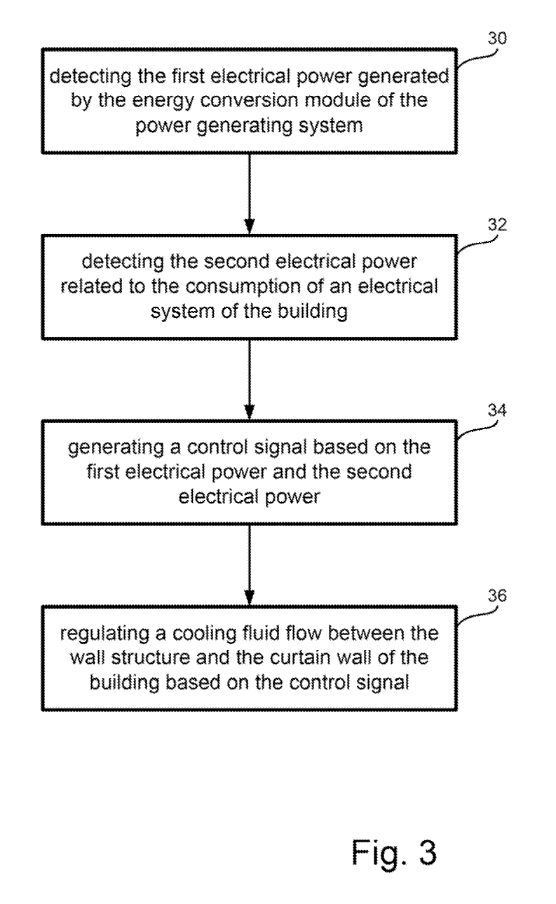

FIG. 3 is a flowchart of a method according to one embodiment of this invention for controlling the power generating system as shown in FIGS. 1A-1B and 2.

In this embodiment, the method starts at step 30, in which the first electrical power P₁ generated by the energy conversion module 10 of the power generating system 1 is detected. At step 32, the second electrical power P₂ related to the consumption of an electrical system 24 of the building 2 is detected. At step 34, a control signal S_{C} is generated based on the first electrical power P₁ and the second electrical power P₂. At step 36, a cooling fluid flow F_{C} between the wall structure 20 and the curtain wall 22 of the building 2 is regulated based on the control signal S_{C}.

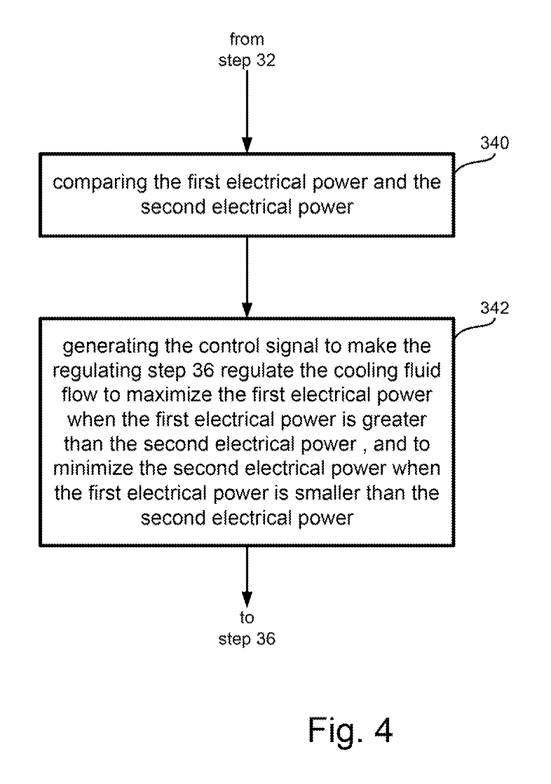

FIG. 4 is a flowchart of step 34 in FIG. 3. As shown, in an embodiment, step 34 may further include step 340 and step 342. At step 340, the first electrical power P₁ and the second electrical power P₂ are compared. Furthermore, at step 342, the control signal S_{C} is generated to make the regulating step regulate the cooling fluid flow F_{C} to maximize the first electrical power P₁ when the first electrical power P₁ is greater than the second electrical power P₂, and to minimize the second electrical power P₂ when the first electrical power P₁ is smaller than the second electrical power P₂.

For example, in the case where the electrical system 24 is an air conditioning system and the temperature inside the building 2 is required to be higher than the temperature outside the building 2 (e.g., in winter), the method may include the step of: generating the control signal S_{C} to make the regulating step increase the cooling fluid flow F_{C} when the first electrical power P₁ is greater than the second electrical power P₂. Alternatively, the method may include the step of: generating the control signal S_{C} to make the regulating step decrease the cooling fluid flow F_{C} when the second electrical power P₂ is greater than the first electrical power P₁.

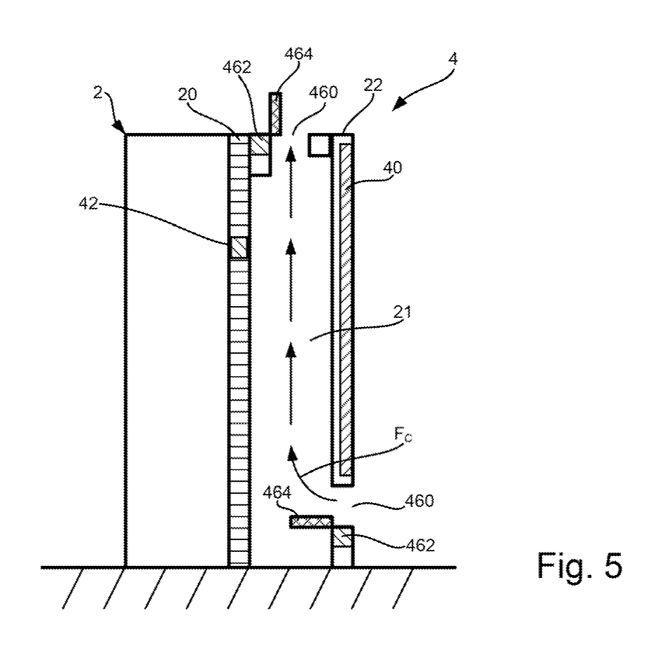

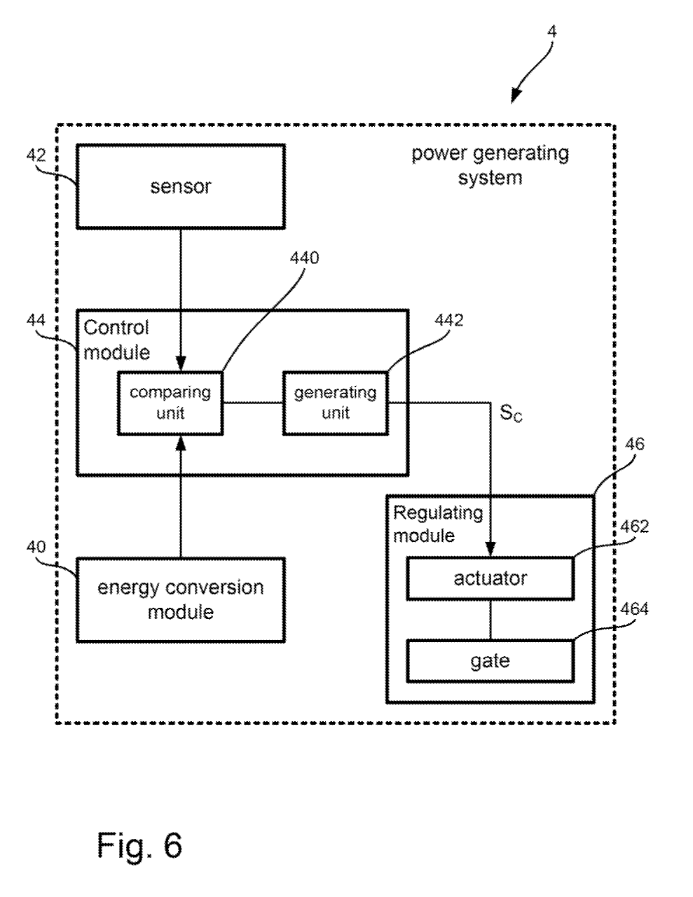

FIG. 5 illustrates a power generating system for a building according to another embodiment of this invention; and FIG. 6 is a block diagram of the power generating system as shown in FIG. 5.

In this embodiment, the building 2 has a wall structure 20 and a curtain wall 22 covering the wall structure 20. The wall structure 20 and the curtain wall 22 can be constructed of any conventional material by a suitable method of construction. Additionally, the power generating system 4 includes an energy conversion module 40, a sensor 42, a control module 44 and a regulating module 46.

The energy conversion module 40 (e.g., a photovoltaic module) can be integrated with the curtain wall 22 for generating an electrical power. The sensor 42 can be used for detecting a current temperature inside the curtain wall 22. The sensor 42 may be disposed inside the wall structure 20, by way of example and not by way of limitation. Alternatively, the sensor 42 may be disposed at any suitable location, for example, in the wall structure 20 or in between the wall structure 20 and the curtain wall 22. In an embodiment, the power generating system 4 of the invention can include a plurality of sensors 42 disposed in at least one proper location of the building 2.

The control module 44 is communicatively connected with the sensor 42, for generating a control signal S_{C} based on the current temperature and a preset temperature. In practice, the control module 44 can be an integrated control unit (ICU) or other suitable module. The preset temperature can be set by a user manually via an operation interface (not shown) communicatively connected with the control module 44. Alternatively, a plurality of values of temperature can be stored as a lookup table in the control module 44 or a memory (not shown) communicatively connected therewith, and the control module 44 can select any one of them to be the preset temperature automatically by using at least one criterion. For example, when the temperature outside the building 2 is much higher than the temperature inside the building 2 (e.g., in summer), the control module 44 can select a lower temperature to be the preset temperature. Alternatively, when the temperature outside the building 2 is much lower than the temperature inside the building 2 (e.g., in winter), the control module 44 can select a higher temperature to be the preset temperature.

Additionally, the regulating module 46 is communicatively connected with the control module 44 for receiving the control signal S_{C} and regulating a cooling fluid flow F_{C} between the wall structure 20 and the curtain wall 22 based on the control signal S_{C}.

As shown in FIG. 6, the control module 44 further includes a comparing unit 440 and a generating unit 442. The comparing unit 440 is communicatively connected with the sensor 42, for receiving the current temperature and comparing the current temperature and the preset temperature. Furthermore, the generating unit 442 is connected with the comparing unit 440, and the generating unit 442 can be applied to generate the control signal S_{C} to make the regulating module 46 regulate the cooling fluid flow F_{C} to minimize a difference between the current temperature and the preset temperature.

For example, the generating unit 442 can generate the control signal S_{C} to make the regulating module 46 increase the cooling fluid flow F_{C} to lower the current temperature when the current temperature is greater than the preset temperature. Alternatively, the generating unit 442 can generate the control signal S_{C} to make the regulating module 46 decrease the cooling fluid flow F_{C} to raise the current temperature when the preset temperature is greater than the current temperature.

In this embodiment, the regulating module 46 may further include at least one opening 460, an actuator 462 and at least one gate 464. The opening 460 can be disposed in fluid communication with a volume 21 defined between the wall structure 20 and the curtain wall 22 for allowing the cooling fluid flow F_{C} through the volume 21. In practice, a plurality of the openings 460 are disposed at different altitudes to facilitate ventilation. The actuator 462 is communicatively connected with the generating unit 442 of the control module 44 for receiving the control signal S_{C}. Additionally, the gate 464 is communicatively connected with the actuator 462 and operatively disposed with the opening 460 for controlling the opening 460 to regulate the cooling fluid flow F_{C}.

In practice, the gate 464 can be electrically and/or mechanically controlled by the actuator 462. Moreover, the gate 464 can control the opening 460 by adjusting the area of the opening 460 or by changing the number of the opening 460 under “open” state or “close” state, by way of example and not by way of limitation.

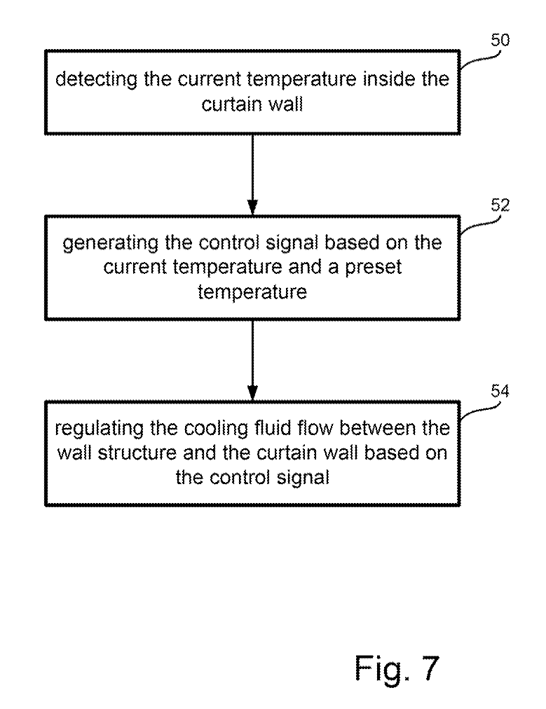

FIG. 7 is a flowchart of a method according to one embodiment of this invention for controlling the power generating system as shown in FIGS. 5 and 6.

In this embodiment, the method starts at step 50, in which the current temperature inside the curtain wall 22 is detected. At step 52, the control signal S_{C} is generated based on the current temperature and a preset temperature. At step 54, the cooling fluid flow F_{C} between the wall structure 20 and the curtain wall 22 is regulated based on the control signal S_{C}. Details and examples of the method can be inferred from the description regarding the power generating system 4 in conjugation with FIGS. 5 and 6, and there is no need to give unnecessary details.

In view of the above, the power generating system for a building and the method for controlling the same can generate power more efficiently and flexibly by regulating a cooling fluid flow between the wall structure and the curtain wall of the building based on the comparison of the electrical power generated by the energy conversion module and the electrical power related to the consumption of the electrical system of the building, or the comparison of the current temperature and the preset temperature.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A power generating system for a building having a wall structure and a curtain wall covering the wall structure, the power generating system comprising:
an energy conversion module integrated with the curtain wall for generating a first electrical power;
a detecting module for detecting a second electrical power related to the consumption of an electrical system of the building;
a control module communicatively connected with the energy conversion module and the detecting module for generating a control signal based on the first electrical power and the second electrical power; and
a regulating module communicatively connected with the control module for receiving the control signal and regulating a cooling fluid flow between the wall structure and the curtain wall based on the control signal.

2. The power generating system of claim 1, wherein the energy conversion module is a photovoltaic module.

3. The power generating system of claim 1, wherein the control module comprises:
a comparing unit for comparing the first electrical power and the second electrical power; and
a generating unit for generating the control signal to make the regulating module regulate the cooling fluid flow to minimize a difference between the first electrical power and the second electrical power.

4. The power generating system of claim 1, wherein the control module comprises:
a comparing unit for comparing the first electrical power and the second electrical power; and
a generating unit for generating the control signal to make the regulating module increase the cooling fluid flow when the first electrical power is greater than the second electrical power.

5. The power generating system of claim 1, wherein the control module comprises:
a comparing unit for comparing the first electrical power and the second electrical power; and
a generating unit for generating the control signal to make the regulating module decrease the cooling fluid flow when the second electrical power is greater than the first electrical power.

6. The power generating system of claim 1, wherein the regulating module further comprises:
at least one opening disposed in fluid communication with a volume defined between the wall structure and the curtain wall for allowing the cooling fluid flow through the volume;
an actuator communicatively connected with the control module for receiving the control signal; and
a gate communicatively connected with the actuator and operatively disposed with the opening for controlling the opening to regulate the cooling fluid flow.

7. The power generating system of claim 6, wherein a plurality of the openings are disposed at different altitudes.

8. A power generating system for a building having a wall structure and a curtain wall covering the wall structure, the power generating system comprising:
an energy conversion module integrated with the curtain wall for generating an electrical power;
a sensor for detecting a current temperature inside the curtain wall;
a control module communicatively connected with the sensor for generating a control signal based on the current temperature and a preset temperature; and
a regulating module communicatively connected with the control module for receiving the control signal and regulating a cooling fluid flow between the wall structure and the curtain wall based on the control signal.

9. The power generating system of claim 8, wherein the energy conversion module is a photovoltaic module.

10. The power generating system of claim 8, wherein the sensor is disposed between the wall structure and the curtain wall.

11. The power generating system of claim 8, wherein the sensor is disposed inside the wall structure.

12. The power generating system of claim 8, wherein the control module comprises:
a comparing unit for comparing the current temperature and the preset temperature; and
a generating unit for generating the control signal to make the regulating module regulate the cooling fluid flow to minimize a difference between the current temperature and the preset temperature.

13. The power generating system of claim 8, wherein the control module comprises:
a comparing unit for comparing the current temperature and the preset temperature; and
a generating unit for generating the control signal to make the regulating module increase the cooling fluid flow when the current temperature is greater than the preset temperature.

14. The power generating system of claim 8, wherein the control module comprises:
a comparing unit for comparing the current temperature and the preset temperature; and
a generating unit for generating the control signal to make the regulating module decrease the cooling fluid flow when the preset temperature is greater than the current temperature.

15. The power generating system of claim 8, wherein the regulating module further comprising:
at least one opening disposed in fluid communication with a volume defined between the wall structure and the curtain wall for allowing the cooling fluid flow through the volume;
an actuator communicatively connected with the control module for receiving the control signal; and
a gate communicatively connected with the actuator and operatively disposed with the opening for controlling the opening to regulate the cooling fluid flow.

16. The power generating system of claim 15, wherein a plurality of the openings are disposed at different altitudes.

17. A method for controlling a power generating system for a building having a wall structure and a curtain wall covering the wall structure, the method comprising steps of:
detecting a first electrical power generated by an energy conversion module of the power generating system;
detecting a second electrical power related to the consumption of an electrical system of the building;
generating a control signal based on the first electrical power and the second electrical power; and
regulating a cooling fluid flow between the wall structure and the curtain wall based on the control signal.

18. The method of claim 17, wherein the step of generating the control signal comprises:
comparing the first electrical power and the second electrical power; and
generating the control signal to make the regulating step regulate the cooling fluid flow to minimize a difference between the first electrical power and the second electrical power.

19. The method of claim 17, wherein the step of generating the control signal comprises:
comparing the first electrical power and the second electrical power; and
generating the control signal to make the regulating step increase the cooling fluid flow when the first electrical power is greater than the second electrical power.

20. The method of claim 17, wherein the step of generating the control signal comprises:
comparing the first electrical power and the second electrical power; and
generating the control signal to make the regulating step decrease the cooling fluid flow when the second electrical power is greater than the first electrical power.
